(19) United States
(12) Patent Application Publication
(10) Pub. No.: US 2007/0083381 A1
(43) Pub. Date: Apr. 12, 2007

(54) Method and system for creating receipt on paper with embedded RFID tags therein

(76) Inventors: David Farrell, Boca Raton, FL (US); Josh Applebaum, Boca Raton, FL (US); Derek Assaf, Boca Raton, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 11/248,811

(22) Filed: Oct. 12, 2005

(51) Int. Cl. G06Q 99/00; G06Q 20/00

(52) U.S. Cl. 705/1; 705/16

(57) ABSTRACT

A central information processing system and method that issues receipts or tickets that can be securely validated at points of redemption. The method and system couple a client system with a server system and also couple at least one Radio Frequency IDentification (RFID) reader to the client system. The method and system read at least one identifier from a sheet with a RFID tag embedded therein with the RFID reader. The method and system also send the at least one identifier from the client system to the server system and receive from the server system at least one receipt image for printing on the paper with the RFID tag embedded therein. The method and system also print, at the client system, a receipt containing ticket information received from the server system. The server system further accepts at least one identifier that was read from a Radio Frequency Identification tag that was read from a sheet at the client system, records the at least one identifier, sends to the client system, in response to the accepting, at least one receipt image. Validation of the receipt or ticket includes reading, at a point of delivery, the at least one identifier from the Radio Frequency Identification tag and providing, in response to reading the at least one identifier, at least one of a good and a service.

### CROSS-REFERENCE TO RELATED APPLICATIONS

Not Applicable.

### BACKGROUND OF THE INVENTION

1. Field of the Invention

This invention generally relates to the field of printers and more particularly to printing on Radio Frequency Identification (RFID) paper.

2. Description of Related Art

Radio Frequency Identification or RFID system is often viewed as a successor to the barcode for tracking information related to an item, person or animal. The advantage of RFID over a barcode is that it does not require direct contact or line-of-sight scanning. An RFID system consists of two components: (1) a reader (combining a transceiver and an antenna) and (2) a tag (combining a transponder and antenna). The reader transmits radio frequency waves that activate a response to the transponder. When activated, the transponder in the tag transmits data back to the reader. There are generally two types of RFID systems in use today; low frequency systems that generally have a range of less than six feet; and high frequency systems that generally have a range of ninety feet or more.

RFID systems that rely on radio waves have distinct advantages over the optical nature of barcodes. One advantage is that an RFID tag, unlike a bar code, does not have to be “seen” by a scanner. With barcodes, the line-of-sight between label and reader is often difficult, impractical, or even impossible to achieve in industrial environments. In order to function properly, it is important for a barcode reader to have clean and clear optics. The bar code label must be clearly printed, free from abrasions and any other distortions, marks, or dirt. Some types of bar code systems further require the reader and label to be properly oriented with respect to each other. In contrast, RFID technology enables tag reading from a greater distance, even in harsh environments.

The amount of information on an RFID tag can vary from an identification number with only a few digits to larger amounts of information, such as an instruction manual on how to assemble an item. For instance, some auto manufacturers use RFID systems to move cars through an assembly line. At each successive stage of production, the RFID tag informs the computers of the next step of automated assembly.

Another trend in the use of RFID systems is the availability of RFID printable labels and paper. One company is IKODE.com of Vienna, VA, (at INKODE.com) which offers printable paper in letter sizes with an RFID tag embedded in the paper. Wordlabel and Avery Dennison announced labels with RFID tags embedded which can be printed on a laser printer. Each of these products enables companies to print information on printers allowing the information on the paper or label to be tracked. By placing RFID readers on doors to a facility, such as a confidential research laboratory where printed information must be tracked, any unauthorized movement of RFID paper with sensitive information printed on it can be tracked like any other asset with a RFID tag. Further, by interfacing RFID transceivers to copiers and shredders, unauthorized duplication or destruction of documents with sensitive information can be tracked and controlled. For example, a specially equipped shredder may not operate if a given RFID tag is not previously authorized for destruction. Similarly, a specially equipped photocopier would not operate unless a given RFID tag is authorized for copying. The combination of RFID tags in paper permits documents to be tracked and controlled in ways never before possible.

One application where barcodes are often deployed is on the use of tickets to concerts, sporting events and other shows, especially in larger arenas and stadiums. Each time a ticket holder passes through an entrance to a given venue, such as a stadium or arena, the barcode is checked against a database to ensure that another ticket-holder previously admitted has not already claimed a specific seat. The use of barcodes reduces the use of multiple forged tickets to the same seat and, in turn, makes scalping more difficult. Although the use of barcodes on tickets to sporting events, concerts and other stadiums has been helpful, it is not without its shortcomings. One shortcoming is being propelled by desktop publishing based on the availability of low cost, high quality digital cameras, photo and graphic editing software which can also reproduce bar codes, and inexpensive desktop color printers. Desktop publishing makes the forgery of printed tickets easier and easier. Accordingly, a need exists to provide a low cost method to reduce the forgery and subsequent scalping of tickets.

Another difficulty with sales and distribution of tickets is the sale of tickets online. Distributors and ticket outlets such as Ticketmaster, make the purchase and distribution of tickets possible using online websites. A patron typically searches for an event of interest and selects available times and seats. Once the patron makes a selection and the payment is received, tickets are mailed to an address. To reduce fraud, the tickets are typically mailed to the billing address associated with the credit card. Although the selection, purchase and payment is all completed online, for security reasons, the physical tickets are mailed to the purchaser thereby increasing the complexity of fulfillment and increasing delay in ticket delivery. This delay in ticket delivery requires, for example, that tickets be purchased one or more days before the event, thereby limiting last minute purchase opportunities. Accordingly, a need exists for a method, system and apparatus to provide a secure method of providing tickets to a purchaser online.

### SUMMARY OF THE INVENTION

According to a preferred embodiment of the present invention, a computing system and method issues receipts or tickets by that can be securely validated at points of redemption. The system and method couple a client system with a server system and also couple at least one Radio Frequency IDentification (RFID) reader to the client system. The system and method read at least one identifier from a sheet with a RFID tag embedded therein with the RFID reader. The system and method also send the at least one identifier from the client system to the server system and receive from the server system at least one receipt image for printing on the paper with the RFID tag embedded therein. The system and method also print, at the client system, a receipt containing ticket information received from the server system. The server system further accepts at least one identifier that was read from a Radio Frequency Identification tag that was read from a sheet at the client system, records the at least one identifier, sends to the client system, in response to the accepting, at least one receipt image. Validation of the receipt or ticket includes reading, at a point of delivery, the at least one identifier from the Radio Frequency Identification tag and providing, in response to reading the at least one identifier, at least one of a good and a service.

### BRIEF DESCRIPTION OF THE DRAWINGS

In the accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a client server system in accordance with an exemplary embodiment of the present invention.

FIG. 2 is a side view of layers of exemplary RFID paper and labels used with an exemplary embodiment in the present invention.

FIG. 3 is a front view of a printer with an integrated RFID reader for reading RFID tags embedded in paper in accordance with an exemplary embodiment of the present invention.

FIG. 4 is a front view of a printer with a separate RFID reader for reading RFID tags embedded in paper in accordance with an exemplary embodiment of the present invention.

FIG. 5 is a process flow for printing receipt or ticket on RFID embedded paper in accordance with an exemplary embodiment of the present invention in paper.

FIG. 6 is an exemplary printing error processing flow 600.

FIG. 7 is an exemplary ticket issuance and validation processing flow 700.

### DESCRIPTION OF THE PREFERRED EMBODIMENTS

Terminology Overview

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as “one or more than one.” The term “plurality,” as used herein, is defined as “two or more than two.” The term “another,” as used herein, is defined as “at least a second or more.” The terms “including” and/or “having,” as used herein, are defined as “comprising” (i.e., open language). The term “coupled,” as used herein, is defined as “connected, although not necessarily directly, and not necessarily mechanically.” The terms “program,” “software application,” and the like as used herein, are defined as “a sequence of instructions designed for execution on a computer system.” A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system. The terms “RFID” refers to Radio Frequency Identification. Low-frequency RFID systems (30 KHz to 500 KHz) generally have short transmission ranges (generally less than six feet). High-frequency RFID systems (850 MHz to 950 MHz and 2.4 GHz to 2.5 GHz) sometimes offer longer transmission ranges (more than 90 feet). RFID is sometimes called dedicated short range communication (DSRC).

The term “RFID paper” or “RFID labels” or “paper with RFID tag embedded” is used to describe any paper stock with a printable surface and an RFID inlay. The paper may include standard size paper such as letter, legal and A4, postcards, labels, envelopes, and photo-quality paper. The printer is any impact or non-impact printer such as a simplex laser printer, ink jet printer, photo printer, and the like, capable of forming images on the printable surface without damaging the RFID inlay.

The term “ticket” or “receipt” is used to denote any paper in which authentication to prevent fraud is desirable at the point of redemption. The term receipt includes a concert ticket, a sporting event ticket, a railway ticket, a bus ticket, a plane ticket, a luggage tag, a gift receipt, a check, a discount coupon, and a money order.

Overview

The present invention, according to one embodiment, overcomes problems with the prior art by providing an integrated and secure method of purchasing receipts or tickets online. After purchase or other authorization to receive the receipt or ticket, the receipt or ticket is printed by the purchaser onto a sheet of paper that includes an RFID tag. The receipt or ticket is printed by using a desktop printer with an RFID reader. The RFID tag in the sheet of paper or label is read in conjunction with the printing of the ticket. An identifier encoded into the RFID tag is transmitted to the web commerce server where the purchase is being made. The identifier in the RFID tag is subsequently read and used to authenticate the receipt or ticket when presented for use by the patron. An image is also able to be printed by the purchaser's local desktop printer onto the sheet of paper containing the RFID tag. The image is any combination of text and graphics and is able to include an indicator related to the identifier, such as a serial number or the like. The likelihood of forging the receipt or ticket printed on RFID paper is greatly diminished because the unique identifier in the RFID tag upon which the receipt or ticket was printed is stored at the webserver and authenticated at the time of redemption. Further, its authentication upon redemption can be tracked to prevent use of duplicate receipts or tickets. The receipt or tickets produced by the exemplary embodiments of the present invention are able to be used in a wide variety of applications, such as concert tickets, sporting event tickets, movie tickets, railway tickets, bus tickets, plane tickets, luggage tags, gift receipts, checks, discount coupons, and money orders. Discount coupons include coupons that are presented at a point of purchase and are redeemed by providing a discount on a specified item or on a total purchase.

Computer System

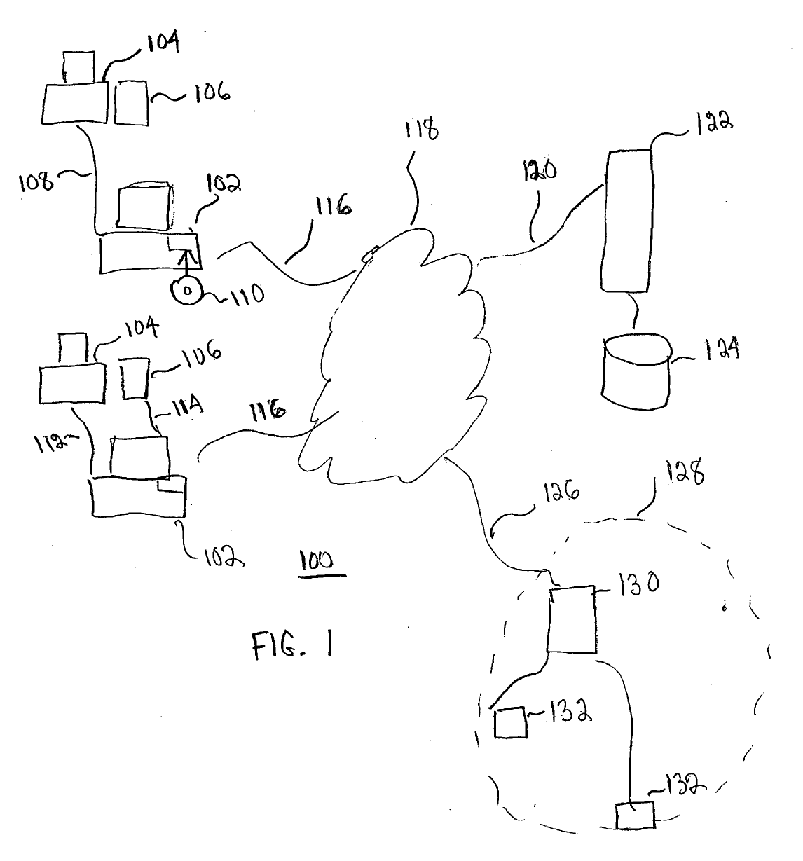

FIG. 1 is a block diagram illustrating a client server system in accordance with an exemplary embodiment of the present invention. The system 100 includes, inter alia, one or more client information processing systems 102, communicating over a network 116 to a communication infrastructure 118, such as the internet, phone system, and the like. A printer is locally coupled to each client information processing system 102 over a local connection 108. The local connection 108 is any bi-directional printer connection including, for example, serial, parallel, Ethernet, USB, Firewire, BlueTooth, IRDA and the like. Coupled to the printer 104 is a RFID reader 106 for reading RFID paper upon which an image is to be formed. It is important to note that the RFID reader 106 in one embodiment is coupled to or integrated with the printer 104. In another embodiment, the RFID reader 106 is coupled directly to the computer 102 through a local connection 114. This local connection 114 again may be any uni-directional or bi-directional connection including, for example, serial, parallel, USB, Keyboard, Firewire, BlueTooth, IRDA and the like. Further, in this embodiment where the RFID reader 106 is coupled directly to the computer, there is no need for a bi-directional local printer connection 112: A uni-directional connection 112 is also within the true scope and spirit of the present invention. Further embodiments operate with various connections between the client information processing system 102, printer 104 and RFID reader 106.

A connection 120 is made from the communication network 118 to a commerce server system 122 that maintains a database 124. Each client information processing system 102 can read at least one identifier from an RFID tag contained within a sheet of RFID paper and transmit that at least one identifier to the server 118. The client information processing system 102 can then access ticket and receipt information from the server 118 and locally print receipts and/or tickets on the sheet of RFID paper by using the coupled printer 104. In one exemplary embodiment, the server is a webserver for rendering web pages over the communications link 114, 116 through the communication infrastructure 114. In further embodiments, server system 122 is one or more data servers that are able to drive other user interfaces or that provide only data communications without directly providing a user interface. Also any connection described herein, such as local connection 108, bi-directional local printer connection 112, communications link, including local connection 114, network 116, connection 120 and connection 126, can be wired, wireless, or any combination of wired and wireless communication links.

The ticket and receipt information that is accessed on and received from the server 118 is able to include image information to be printed on the sheet of RFID paper. Receipt image data is able to include any type of graphical and/or textual information as is commonly included on tickets, such as seat and section identifiers, time and date information, and the like. In addition, an indicator that is associated with the identifier is also able to be included in image information that is printed on the receipt or ticket. An example of such an indicator is a serial number or other unique alphanumeric sequence that identifies the receipt or ticket. The use of this serial number allows, for example, alternative authentication in the case of a failure of the RFID readers 132 at the venue 128 or failure of the RFID tag within the receipt or ticket itself. This indicator is able to be stored in database 124 in association with the identifier stored in the RFID tag.

Once a receipt or ticket is printed, the user takes the receipt or ticket to a venue 128, which may include, for example, any entertainment hall such as a concert hall, stadium, theater, arena and the like; a transportation facility, such as a bus station, train station, airport; or a retail location, such as a store. Venues 128, or any type of facility that accept any type of token in exchange for goods or services are within the scope of this invention. The venue 128 includes one or more RFID readers 132 coupled to a gateway 130 which is connected to the communication infrastructure 118 via connection 126. The identifier stored in the RFID tag embedded in the presented receipt or ticket is read by the RFID reader 132 at venue 128. The identifier read by the RFID reader 132 is then compared to identifiers stored in database 124 in order to authenticate whether the presented receipt or ticket matches an identifier of a previously purchased receipt or ticket. The identifier read at the venue 128 is validated if it matches an identifier that was stored when the receipt or ticket was initially requested from server system 122. Central or distributed web servers 122 are further able to operate with a database 124 incorporating any database structure, such as central, distributed, object oriented, relational, and the like. The identifiers read by the RFID readers 132 at the venue are able to be communicated to the server system 122 for comparison to identifiers stored in database 124, or a copy of identifiers stored in database 124 can be m maintained on a computer located at or near the venue 128 and used for validation.

Note for simplicity, only one web server system 122 and database 124 and venue 128 is shown in FIG. 1. The present invention works advantageously well with multiple venues and web servers coupled to the communication infrastructure 118.

Software and Computer Pro gram Medium

In this document, the terms “computer program medium,” “computer-usable medium,” “machine-readable medium,” “computer program product” and “computer-readable medium” are used to generally refer to media such as removable storage drive 110. These computer program products are means for providing software to the client information processing system 102. The computer-readable medium allows the client information processing system 102 to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may comprise computer-readable information in a transitory state medium such as a network link and/or a network interface, including a wired network or a wireless network, which allows a computer to read such computer-readable information.

Various software embodiments are described in terms of this exemplary system. In view of this description of an exemplary embodiment of the present invention, it will become apparent to a person of ordinary skill in the relevant art(s) how to implement the invention using other computer systems and/or computer architectures.

RFID Paper and/or Label

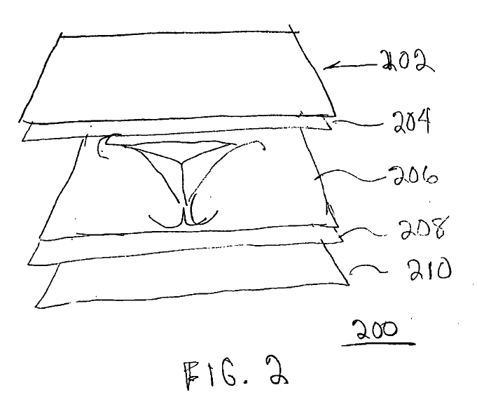

FIG. 2 is a side view of layers of exemplary RFID paper and labels 200 used with an exemplary embodiment in the present invention. An RFID tag 206 is sandwiched, using top adhesive 204 and bottom adhesive 208, between a printable top face 202 and a back liner 210. It is important to note that RFID tag 206 as shown is not to scale. More typically the RFID is not as large as the printable paper size which occupies less than 10 percent of the total surface area of the printable paper stock.

Printer With Integrated RFID Reader

FIG. 3 is a front view of an embodiment of the present invention that includes a printer with an integrated RFID reader 300 for reading RFID tags embedded in paper in the present invention. In this embodiment, the RFID Reader 106 is positioned above a tray 302 of printer 104 where the paper sheets that have an embedded RFID tag 200 is inserted. As a sheet of RFID paper 200 are fed into the paper insert 302 of printer 104, the RFID reader 106 is used to read the RFID tag embedded in the sheet. Only one communications link 108 is necessary between this embodiment and the client information processing system in this embodiment.

Printer With Separate RFID Reader

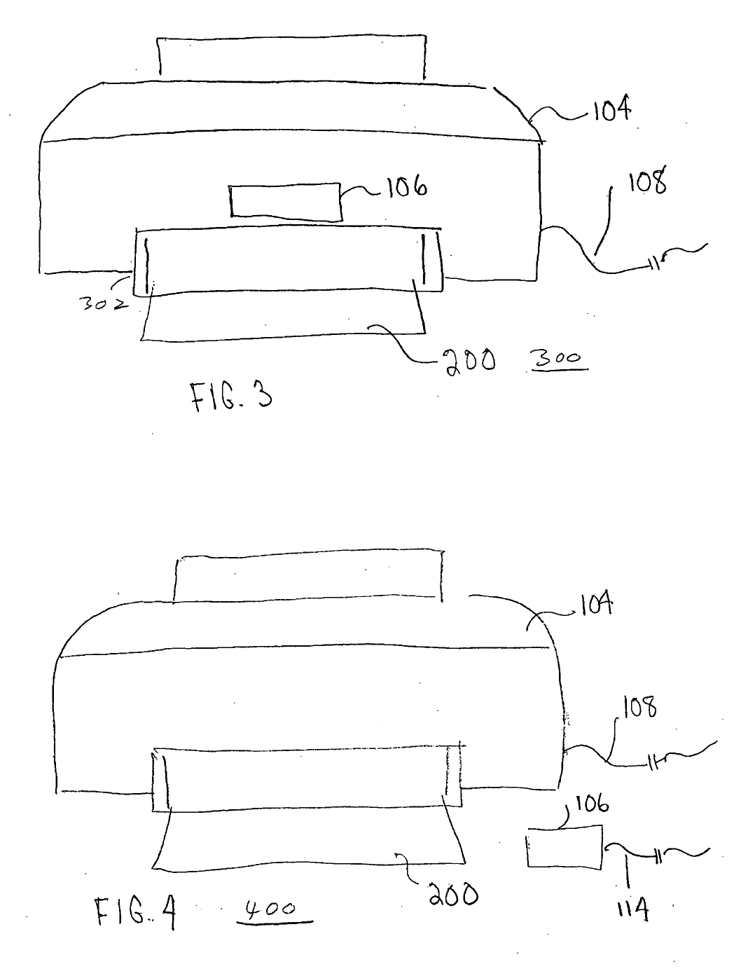

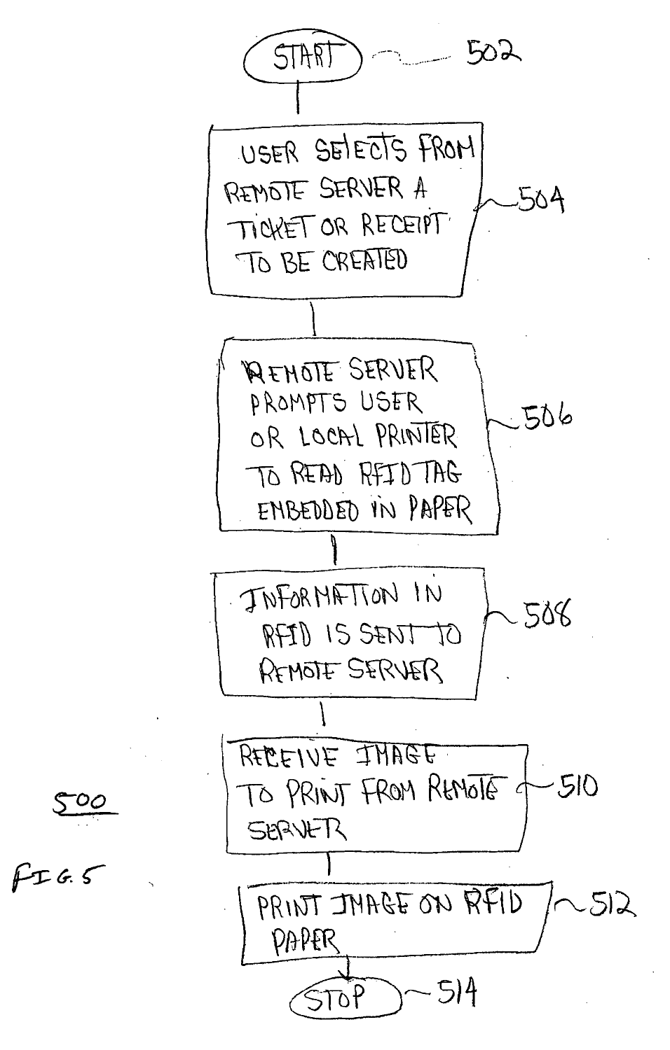

FIG. 4 is a front view of a printer with a separate RFID reader 400 for reading RFID tags embedded in paper as used in some embodiments of the present invention. In this embodiment, the RFID Reader 106 is a separate, free standing or handheld device and the paper with embedded RFID tag 200 is scanned either before being inserted into the printer or as the paper with embedded RFID tag 200 is feeding into the printer 200 for printing. The RFID tag is further able to be scanned after the paper with embedded RFID tag 200 is printed. In this embodiment, two communications links (one communication link 108 for the printer 104 and one communication link 114 for the RFID Reader 106) is used in this embodiment to connect these devices to the client information processing system. Further embodiments are able to share this link.

Process Flow for Printing Receipt or ticket On RFID Embedded Paper

FIG. 5 is a process flow for printing tickets or receipts on RFID embedded paper in accordance with an exemplary embodiment of the present invention in paper. The process begins in step 502 and immediately continues in step 504 on the client information processing system 102 when a user from a remote server selects a receipt or ticket to be generated. In one embodiment, the remote server system 122 is a ticket agency, such as Ticketron, Ticketmaster, a retail store, travel agency, transportation provider, and any other retailer of a good or service in which authenticated receipts or tickets are desirable. After a particular receipt or ticket is selected by the user, the web server 122 in one embodiment notifies the printer 104 with integrated RFID reader coupled to the client information processing system 102 to read an RFID tag embedded in a paper, in step 506.

In another embodiment, after a particular receipt or ticket is selected by the user, the web server prompts the user to scan the RFID tag embedded in the paper as illustrated in step 506. In these embodiments, the RFID reader is either integrated into the printer 104 as shown in FIG. 3 or separate from the printer 104 as shown in FIG. 4.

The information in the RFID tag is sent from the RFID reader 106 through the client information processing system 102 to the server system 122 in step 508. This causes the information in the RFID tag to be stored in the data base 124 as a valid receipt or ticket.

Next, in step 510, an image for the receipt or the ticket is received by the client information processing system 102 and printed on the paper with the RFID tag embedded, step 512.

It is important to note, that other optional sub steps (not shown) such as again verifying the information in the RFID tag on the paper just prior to printing the received image ensures that the user is not switching paper in the printer.

Errors in printing, e.g. printer jams, out of toner, out of ink, are handled by reprinting a ticket and having the client information system send a void notification to the server system 122 of the previous transaction by rescanning the paper with the embedded RFID tag to be voided. A new paper with an RFID tag is subsequently scanned and the process repeats as outlined in FIG. 5.

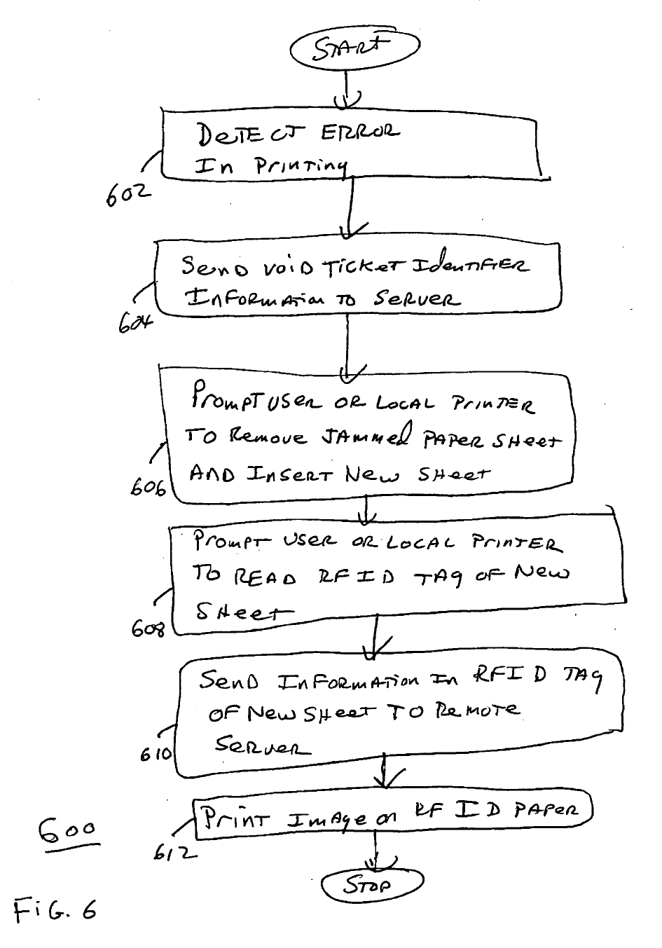

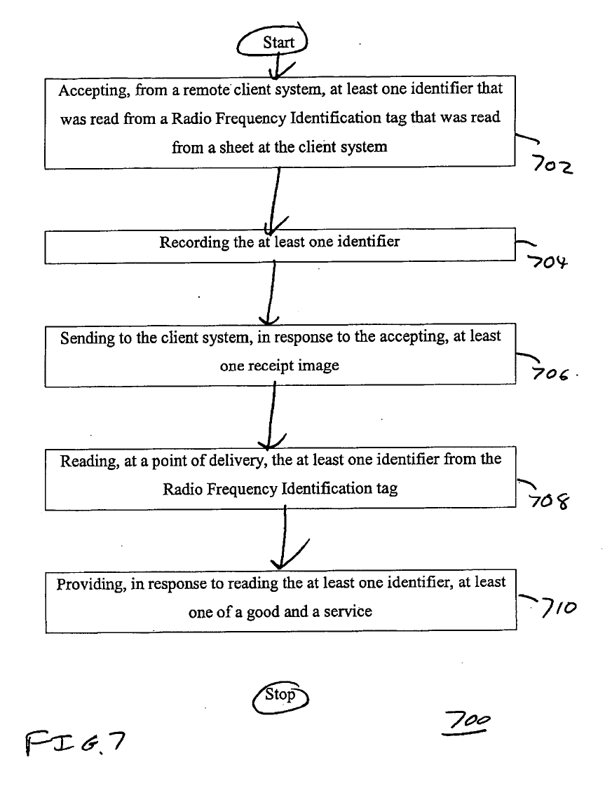

FIG. 6 is an exemplary printing error processing flow 600. The printing error processing flow 600 begins by detecting, at step 602, an error in printing. This error is able to be detected, for example, either by automated equipment within printer 104 or by an input from the user. The processing then sends, at step 604, a void ticket identifier information to the server system 122. This information instructs the server system 122 to revoke the validity of the RFID information that was previously transmitted. In the exemplary embodiment, the RFID tag information is resent in this void identifier information. The server system 122 then removes this RFID tag information from database 124.

The processing next prompts, at step 606, the user or local printer to remove the jammed paper sheet and to insert a new sheet of RFID paper. Such removal may be performed by the printer itself, depending upon the error, or may require manual intervention by the user. The processing next prompts, at step 608, the user or local printer to read the RFID tag embedded within a new sheet of RFID paper. This may require the user to insert a new sheet of RFID paper or perform other manual tasks, as is described above. The processing next sends the information contained in the RFID tag of the new sheet of RFID paper to the remote server system 122. In the exemplary embodiment of the present invention, this new RFID tag information is stored in the database 124 as the valid identifier for this receipt or ticket. The printer then prints, at step 612, the image in the RFID paper. In the exemplary embodiment, this is the image that was previously used. In further embodiments, a new image is able to be received from the server system 122 to be printed on the replacement receipt or ticket. The processing then stops.

FIG. 7 is an exemplary ticket issuance and validation processing flow 700. The ticket issuance and validation processing begins by accepting from a remote client system, at step 702, at least one identifier that was read from a Radio Frequency Identification tag that was read from a sheet at the client system. The processing continues by recording, at step 704, the at least one identifier. The processing next sends to the client system in response to the accepting, at least one receipt image, at step 706. The processing contuse by reading at a point of delivery, at step 708, the at least one identifier from the Radio Frequency Identification tag. This exemplary processing then provides, in response to reading the at least one identifier, at least one of a good and a service at step 710. The processing then terminates.

The operation of the above exemplary embodiments of the present invention provides many advantages over prior art systems. For example, the printing of tickets and/or receipts by the end user shifts the cost of the paper and printing to the end user and away from the entity providing the ticket and/or receipt. These costs include not only the costs of expendables, such as paper and ink, but also include the cost of having multiple facilities to provide the tickets and/or receipts. In the example of concert tickets, the number of ticket booths at a venue is able to be reduced if pre-purchased tickets are not required to be printed for pick-up at the venue, but are instead printed by the ticket holder. The convenience for the customer of not having to go to a ticket vendor or wait in line for a pre-purchased ticket to be provided at the ticket booth of the venue will significantly increase the convenience of event attendance for the customer.

These exemplary embodiments of the present invention include an application wherein discount coupons, such as coupons that provide a discount upon presentation at a point-of-purchase, can be printed by a consumer : These coupons will advantageously be difficult to counterfeit. These coupons will have the further advantage that, as described above, the cost of printing these coupons is shifted to the consumer who will use them. This example has a further advantage that only consumers who desire the coupons print them, thereby reducing the wasted paper produced by mass-distribution of printed coupons.

Non Limiting Hardware and Software Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method to create a receipt with a Radio Frequency IDentification (RFID) embedded therein on a client system, the method on a client system comprising:
coupling a client system with a server system;
coupling at least one Radio Frequency IDentification (RFID) reader to the client system;
reading, with the RFID reader, at least one identifier from a sheet with a RFID tag embedded therein;
sending the at least one identifier from the client system to the server system;
receiving from the server at least one receipt image for printing on the paper with the RFID tag embedded therein; and
printing, at a client system, a receipt containing ticket information received from the server system.

2. The method of claim 1, further comprising
printing on at least one printer coupled to the client system the receipt image on the paper with the RFID tag embedded therein.

3. The method of claim 1, wherein the receiving from the server further comprising receiving from the server at least one receipt image with a printable image containing an indicator associated with the identifier.

4. The method of claim 1, wherein the receipt image is selected from a group of receipt images consisting of a concert ticket, a sporting event ticket, a movie ticket, a railway ticket, a bus ticket, a plane ticket, a luggage tag, a gift receipt, a check, a discount coupon, and a money order.

5. A system for creating a receipt with a Radio Frequency IDentification (RFID) embedded therein, the method on a client system comprising:
a communications interface that couples to a server system;
a printer;
a Radio Frequency Identification (RFID) reader that reads at least one identifier from a RFID tag embedded in a sheet proximately located near the printer; and
a receipt validation processor, communicatively coupled to the communications interface, the Radio Frequency Identification reader and the printer, that
accepts the at least one identifier;
transmits the at least one identifier to the server system;
receives from the server at least one receipt image; and
causes the printer to print the at least one receipt image on the sheet with the RFID tag embedded therein.

6. The system of claim 5, wherein the receipt validation processor further causes the printer to print the at least one receipt image on the paper with the RFID tag embedded therein.

7. The system of claim 5, wherein the receipt validation processor further receives from the server at least one receipt image with a printable image containing an indicator associated with the identifier.

8. The system of claim 5, wherein the receipt image is selected from a group of receipt images consisting of a concert ticket, a sporting event ticket, a movie ticket, a railway ticket, a bus ticket, a plane ticket, a luggage tag, a gift receipt, a check, a discount coupon, and a money order.

9. A method of issuing a receipt with a Radio Frequency Identification (RFID) embedded therein, the method comprising:
accepting, from a remote client system, at least one identifier that was read from a Radio Frequency Identification tag that was read from a sheet at the client system;
recording the at least one identifier;
sending to the client system, in response to the accepting, at least one receipt image;
reading, at a point of delivery, the at least one identifier from the Radio Frequency Identification tag; and
providing, in response to reading the at least one identifier, at least one of a good and a service.
